(19) United States
(12) Patent Application Publication
(10) Pub. No.: US 2025/0227012 A1
(43) Pub. Date: Jul. 10, 2025

(54) TRANSCEIVER

(71) Applicant: Fraunhofer-Gesellschaft zur Förderung der angewandten Forschung e.V., München (DE)

(72) Inventors: Birendra GHIMIRE, Erlangen (DE); Mohammad ALAWIEH, Erlangen (DE); Ernst EBERLEIN, Erlangen (DE); Norbert FRANKE, Erlangen (DE)

(21) Appl. No.: 19/092,312

(22) Filed: Mar. 27, 2025

Related U.S. Application Data
(63) Continuation of application No. PCT/EP2023/076953, filed on Sep. 28, 2023.

(30) Foreign Application Priority Data
Sep. 30, 2022 (EP) 22199133.4

(51) Int. Cl. H04L 27/26; H04L 5/00; H04W 56/00; H04W 64/00; H04W 72/044

(52) U.S. Cl. CPC H04L 27/2605; H04L 5/0007; H04W 56/0045; H04W 64/00; H04W 72/044

(57) ABSTRACT

An embodiment of the present invention provides a transceiver, which is configured to receive a first reference signal to transmit a second reference signal. The first reference signal is received at a second point of time by the transceiver, wherein same reference signal is transmitted by another transceiver at a first point of time. The transceiver, also referred to as responder, transmits the second reference signal (e.g., as a response to the first reference signal), wherein the first sample of the second reference signal is transmitted at a third point of time, but modified by a cyclic shift defined by a cyclic shift value. The cyclic shift value is derived from the second point of time (measured time-of-arrival (ToA)) of the received first reference signal and a time information associated with a fifth point of time.

### CROSS-REFERENCE TO RELATED APPLICATIONS

This application is a continuation of copending International Application No. PCT/EP2023/076953, filed Sep. 28, 2023, which is incorporated herein by reference in its entirety, and additionally claims priority from European Application No. EP 22199133.4, filed Sep. 30, 2022, which is also incorporated herein by reference in its entirety.

Embodiments of the present invention refer to a transceiver and to a user equipment comprising the transceiver. Another embodiment refers to a system comprising user equipments with a transceiver and another user equipment or base station. Another embodiments refers to a method for exchanging reference signals and to corresponding computer programs. In general, embodiments of a present invention are in the field of positioning technologies for communication devices.

### BACKGROUND OF THE INVENTION

FIG. 1 is a schematic representation of an example of a terrestrial wireless network 100 including, as is shown in FIG. 1(a), the core network 102 and one or more radio access networks RAN₁, RAN₂, . . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1(b) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 1161 to 1165, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st} stage SCI, and optionally, a second control region which contains a second part of control information, also referred to as the 2nd stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 2a, in addition to the NR mode 1 or LTE mode 3 UEs 202, 204 also NR mode 2 or LTE mode 4 UEs 206, 208, 210 are present. In addition, FIG. 2b, schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210

Although FIG. 2a and FIG. 2b illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

Within the above-mentioned communication networks, a precision can be determined or estimated by determining a so-called round trip time (RTT). When performing an RTT measurement, a signal or reference signal is exchanged between one device, e.g., a UE and another device, like another UE or a base station. The RTT measurements are well supported by the 3GPP standards. Current procedures involve that the first UE can report to an network or another device, or if the range is calculated by the UE itself, the UE can receive measurement reports, e.g., from the network or from another UE (in case of a sidelink). Therefore, there is a need for an improved approach.

### SUMMARY

An embodiment may have a transceiver configured: to receive a first reference signal at a second point of time, the first reference signal is transmitted by another transceiver at a first point of time; and to transmit a second reference signal, wherein the second reference signal is set for transmission at a third point of time, wherein the second reference signal is modified by a cyclic shift defined by a cyclic shift value; wherein the cyclic shift value is derived from the second point of time (measured time-of-arrival (ToA)) of the received first reference signal and a time information associated with a fifth point of time.

Another embodiment may have a transceiver which is configured: to transmit a first reference signal at a first point of time, the first reference signal is received by another transceiver at a second point of time; and to calculate a time of arrival of a second reference signal based on a measurement performed by another transceiver or to perform a measurement of a time of arrival of a second reference signal; wherein the second reference signal is set for transmission at a third point of time, wherein the second reference signal is modified by a cyclic shift defined by a cyclic shift value; and to calculate and/or report a range based on calculated or measured time of arrival based on an information on a third or fifth point of time without receiving or accessing a measurement report from the transceiver transmitting the second reference signal; wherein the cyclic shift value is derived from the second point of time (measured time-of-arrival) of the received first reference signal and a time information associated with a fifth point of time.

Another embodiment may have a user equipment including one of the inventive transceivers, wherein the other transceiver is part of a base station.

Another embodiment may have a user equipment including one of the inventive transceivers, wherein the other transceiver is part of another user equipment, wherein the user equipment and the other user equipment communicating to each other using sidelink communication.

Another embodiment may have a user equipment including any one of the inventive transceivers, wherein the user equipment is out of the group including:
user device, UE,
a power-limited UE,
a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE,
an IoT UE, e.g., a sensor, an actuator or a UE provided in a campus network to carry out repetitive tasks and needing input from a gateway node at periodic intervals,
a mobile terminal,
a stationary terminal,
a cellular IoT-UE,
a vehicular UE,
a vehicular group leader, GL, UE,
an IoT, or a narrowband IoT, NB-IoT, device, or a WiFi non Access Point STAtion, non-AP STA, e.g., 802.11ax or 802.11be,
a ground based vehicle, or an aerial vehicle,
base station, like e gNB or eNB,
a drone, or a moving base station,
a road side unit, or a building, or any other item or device provided with network connectivity enabling the item/device to communicate using the wireless communication network, e.g., a sensor or actuator,
any other item or device provided with network connectivity enabling the item/device to communicate using a sidelink the wireless communication network, e.g., a sensor or actuator, or any sidelink capable network entity.

Another embodiment may have a system including a user equipment including one of the inventive transceivers, wherein the other transceiver is part of a base station and another user equipment including one of the inventive transceivers, wherein the other transceiver is part of another user equipment, wherein the user equipment and the other user equipment communicating to each other using sidelink communication or a base station, wherein the other user equipment or the base station include the other transceiver.

Another embodiment may have a method for performing localization having the steps of: transmitting a first reference signal at a first point of time, the first reference signal is received by another transceiver at a second point of time; calculating a time of arrival of the second reference signal based on a measurement performed by another transceiver or to perform a measurement of a time of arrival of the second reference signal; and calculating a range based on the calculated or measured time of arrival based the known or measured time-of-transmit of RS1 and the known or configured difference between the second and fifth point of time without receiving or accessing a measurement report from the transceiver transmitting the second reference signal; wherein the second reference signal is set for transmission at a third point of time, wherein the second reference signal is modified by a cyclic shift defined by a cyclic shift value; wherein the cyclic shift value is derived from the second point of time (measured time-of-arrival) of the received first reference signal and a time information associated with a fifth point of time.

Another embodiment may have a method for exchanging reference signals, the method having the steps of: receiving a first reference signal at a second point of time, the first reference signal is transmitted by another transceiver at a first point of time; and transmitting a second reference signal, wherein the second reference signal is set for transmission at a third point of time, wherein the second reference signal is modified by a cyclic shift defined by a cyclic shift value; wherein the cyclic shift value is derived from the second point of time (measured time-of-arrival) of the received first reference signal and a time information associated with a fifth point of time.

Another embodiment may have a non-transitory digital storage medium having a computer program stored thereon to perform any of the inventive methods when said computer program is run by a computer.

An embodiment of the present invention provides a transceiver, which is configured to receive a first reference signal to transmit a second reference signal. The first reference signal is received at a second point of time by the transceiver, wherein same reference signal is transmitted by another transceiver at a first point of time. The transceiver, also referred to as responder, set for transmission (transmits) the second reference signal (e.g., as a response to the first reference signal), wherein the transmit time (represented by the begin (e.g. first sample) of an OFDM symbol or another reference point of the OFDM symbol such as begin of the main symbol, etc.) of the second reference signal is considered as a third point of time. But the second reference signal is modified by a cyclic shift defined by a cyclic shift value. The cyclic shift value is derived from the second point of time (measured time-of-arrival (ToA)) of the received first reference signal and a time information associated with a fifth point of time.

Another embodiment provides a user equipment comprising a transceiver. Here, the other transceiver may be part of a base station or part of another user equipment (sidelink).

Another embodiment refers to a system comprising the user equipment and the other user equipment or the base station.

Another embodiment provides a method for exchanging reference signals. The method comprises the following steps:
Receiving a first reference signal and a second point of time, the first reference signal is transmitted by another transceiver at a first point of time; and
Transmitting a second reference signal, wherein (the first sample of) the second reference signal is set for transmission or transmitted at a third point of time, wherein the second reference signal is modified by a cyclic shift defined by a cyclic shift value. The focus on the cyclic shift value is derived as discussed above.

According to embodiments, the method may be computer implemented.

### BRIEF DESCRIPTION OF THE DRAWINGS

Embodiments of the present invention will be detailed subsequently referring to the appended drawings, in which:

FIGS. 1a and 1b show schematic representations of a terrestrial wireless network in different configurations to discuss the background of embodiments;

FIG. 2a shows a schematic representation of an in coverage scenario;

FIG. 2b shows a schematic representation of an out of coverage scenario;

FIG. 3 shows a schematic diagram illustrating the RTT signal timing;

FIG. 4 shows a schematic diagram illustrating the RTT using cyclic shift according to embodiments;

FIG. 5a schematically illustrates the structure of a OFDM symbols (without cyclic shift) and an example of a correlation to illustrate embodiments;

FIG. 5b schematically illustrates the cyclic shifted OFDM symbol and the resulting impact to the according to embodiments;

FIG. 5c schematically illustrates a possible implementation of the cyclic correlation. In the example a implementation in the time domain is illustrated.

FIG. 6 shows a schematic block diagram illustrating a method for position determination according to embodiments;

FIG. 7a shows a schematic application scenario with roadside units (RSUs) according to an embodiment;

FIG. 7b shows a schematic diagram illustrated the correlator output of the three RSU according to the embodiment of FIG. 7a;

FIG. 8 schematically illustrates a position determination approach for communication networks with devices, here RSUs, an LMF and a gNB entity according to an embodiment;

FIG. 9 schematically shows a configuration, where one initiator UE communicates with one or more responder UEs according to an embodiment;

FIG. 10 schematically shows a block diagram of different UEs for discussing the principle of position determination according to embodiments;

FIG. 11a schematically shows a flow chart for a procedure with involvement of a LMF

FIG. 11b schematically shows a flow chart for a procedure of a target UE according to an embodiment;

FIG. 12 schematically shows a principle of position computation using sidelink and calculation of the position by the UE;

FIG. 13 shows a schematic block diagram of a hardware implementation.

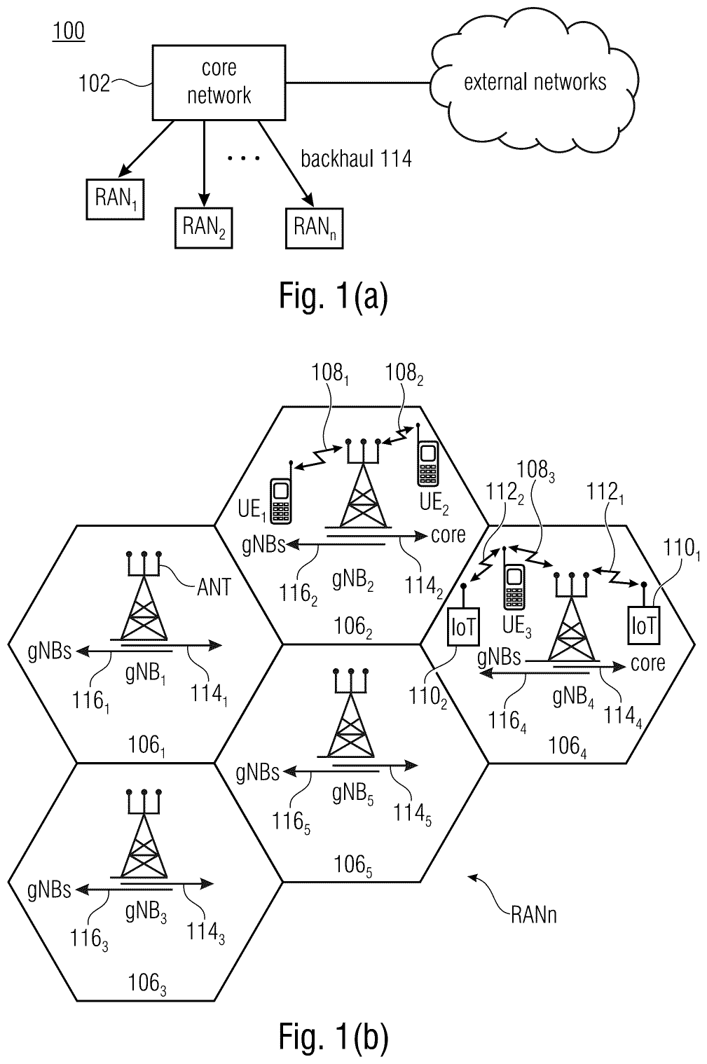

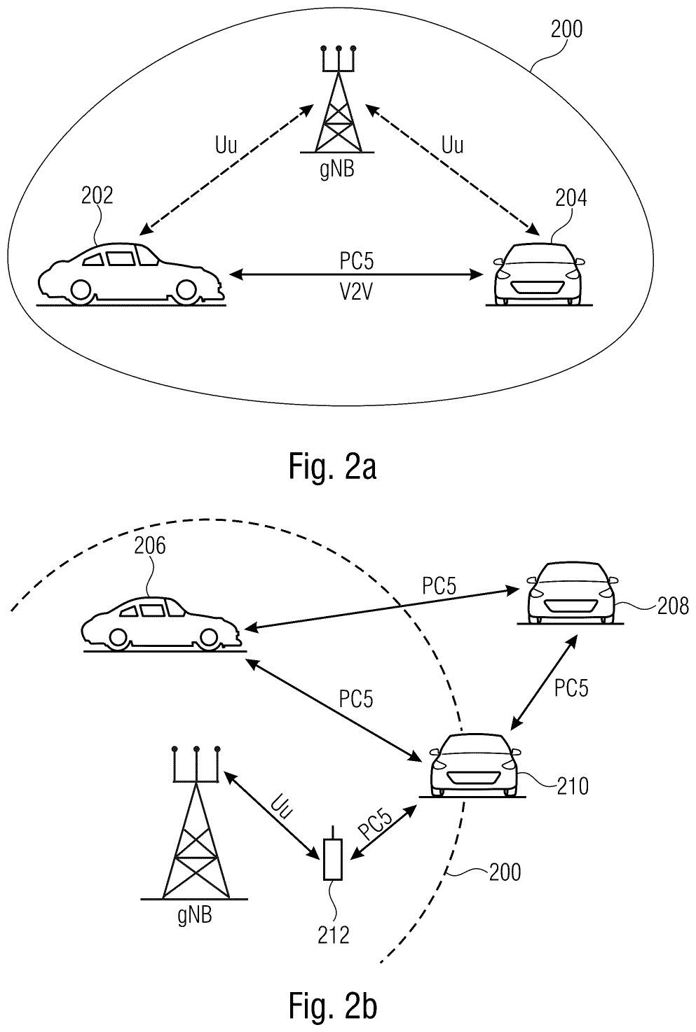

### DETAILED DESCRIPTION OF THE INVENTION

Below, embodiments of the present invention will subsequently be discussed referring to the enclosed figures, wherein identical reference numbers are provided to objects having identical or similar function, so that the description thereof is mutually applicable and interchangeable.

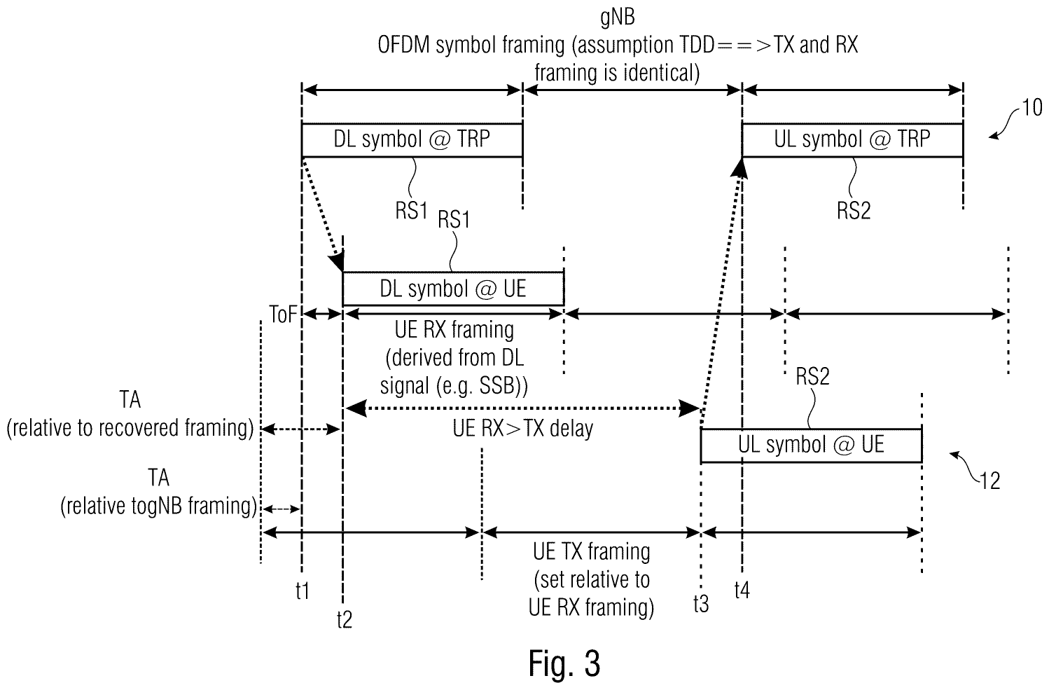

Before discussing embodiments of the present invention, the principle for RTT measurements (roundtrip time) will be discussed. A procedure for determining the RTT may be characterized as follows: here, reference is taken to FIG. 3.

In the low row of FIG. 3, the received and transmitted procedure of a transceiver 12, e.g., of a UE will be discussed. The steps of receive and transmit are referred to as downlink symbols @ UE (cf. RS1) and uplink symbols @ UE (cf. RS2). The communication established to another entity 12, here a transmission point which is illustrated in the top row of FIG. 3. The transmit procedure and receive procedure are referred to as DL symbol @ TRP and UL symbol @ TRP.

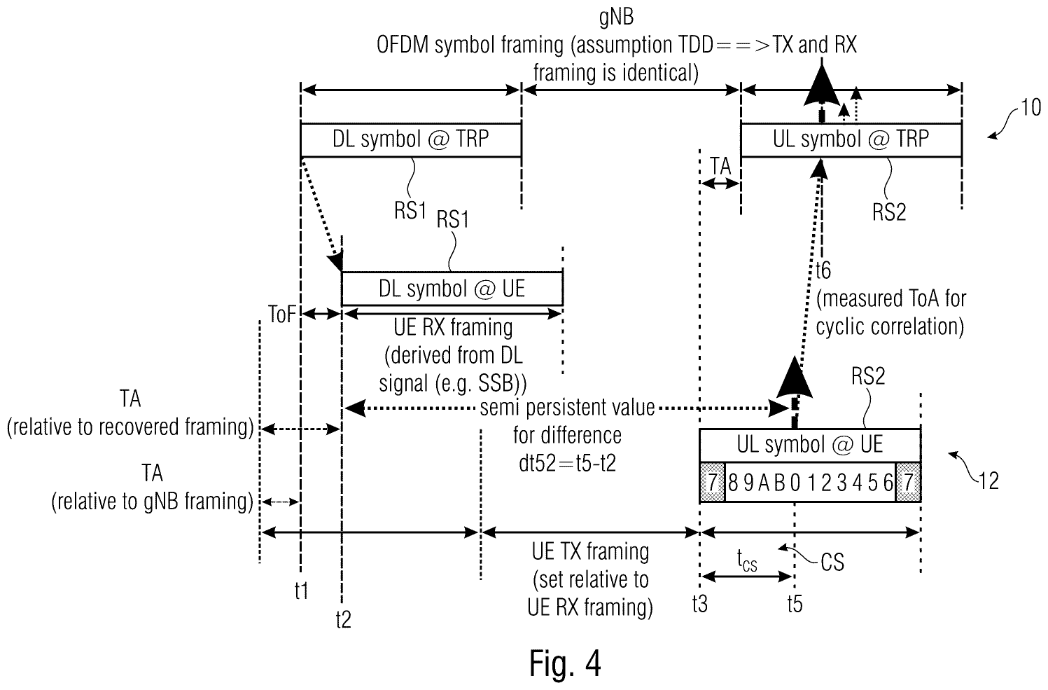

The steps performed by the two entities are described below:
1. The network (or in case of sidelink a UE) defines reference signals (RS1, RS2) useful for ToA (time of arrival) measurements and transmits the signal in the DL (or forward link). For simplicity reasons we consider in the following the gNB/UE operation only. But the concept is fully applicable to sidelink also.
2. The network reports the RS configuration to the UE 12.
3. The network configures RS2 (typically a SRS) for the UL transmission. The configuration includes the slot(s) used for the UL signal, the position or positions in the slot, the OFDM symbol parameter and the RS sequence parameters.
4. Furthermore, the network adjusts the timing advance (TA) and configures the power control for the UL.
5. The TA setting and the RS signal configuration defines the ToT (time of transmit) of the RS
6. For RTT measurements the UE reports the time difference between the ToA and ToT (t3−t2) with a high time resolution
7. For the reporting the network has to establish a communication link for the exchange of the reports.
8. The network measures the DL ToT (t1 in the FIG. 3 or 4) of RS1 and the ToA (t4) of the UL signal RS2
9. From the 4 time values t1 . . . t4 the ToF (time of flight) can be calculated by

$$ToF = ( ( {t}_{4} - {t}_{1} ) - ( {t}_{3} - {t}_{2} ) ) / 2$$

10. From the ToF the distance can be calculated.

The procedure as it is discussed above or illustrated by FIG. 3 typically uses (or needs) that the UE can report to the network (TRP 10), or if range is calculated by the UE 12 itself that the UE 12 can receive measurement ports from the network or from another UE in the case of sidelink.

For positioning, the following issues may be relevant: The reporting needs a signal that can be decoded without errors. This may need a higher UE TX power (to ensure that the signal arrives with sufficient SINR). The reporting may introduce additional latency. Several links have to be established for triangulation-based positioning. For positioning the RS can be processed even if they are received at very low SINR due to the correlation gain which corresponds to the length of the sequence. This allows
Use far away gNBs (or UEs) for the measurements, even if the pathloss is high and the UE is not able to receive or to transmit reports to this network entity.
Alternatively, the UE may transmit the signals with lower power only to minimize the interference to other devices (e.g. gNB close to the UE). Only in the configuration phase the UE (or another network entity) may use a transmit power sufficient for sending configuration information.

In the current procedure it is assumed that a reporting is possible (either direct or indirect) and the latency is not critical.

In the context of positioning reference signal design, we demonstrated that for positioning it is sufficient to receive the reference signals with very low SINR (e.g. −20 dB). This low SINR operation is not supported for communication. Accordingly, the reporting has to be established by other links (for example reporting to the nearest gNB or UE and exchange of information between gNBs. Each UE transmits or receives measurements from its “serving-gNB”, which may be typically the gNB nearest to the UE. Or a higher signal power is configured for the reporting, which may generate more interference or even overload of a nearby gNB.

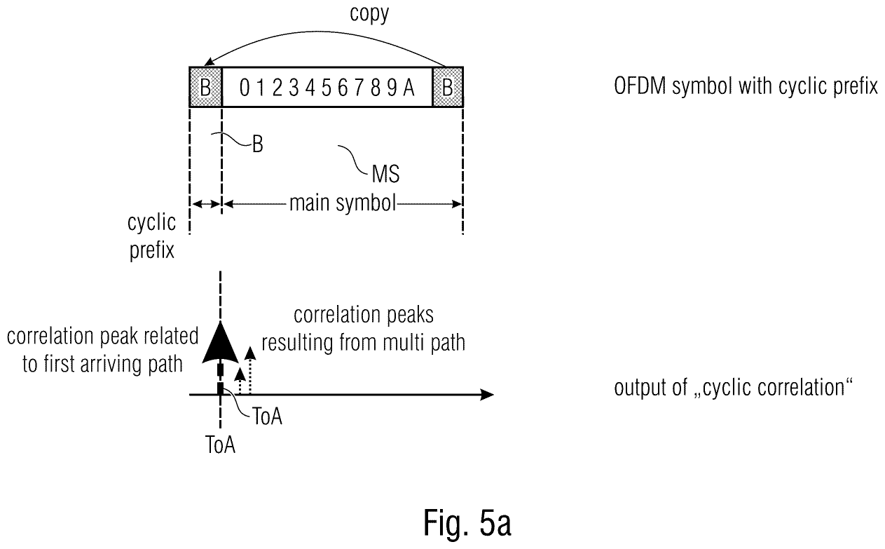

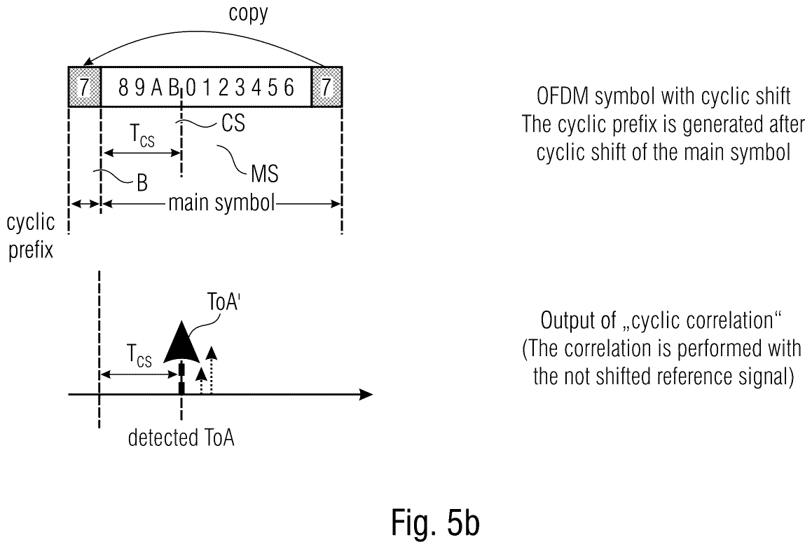

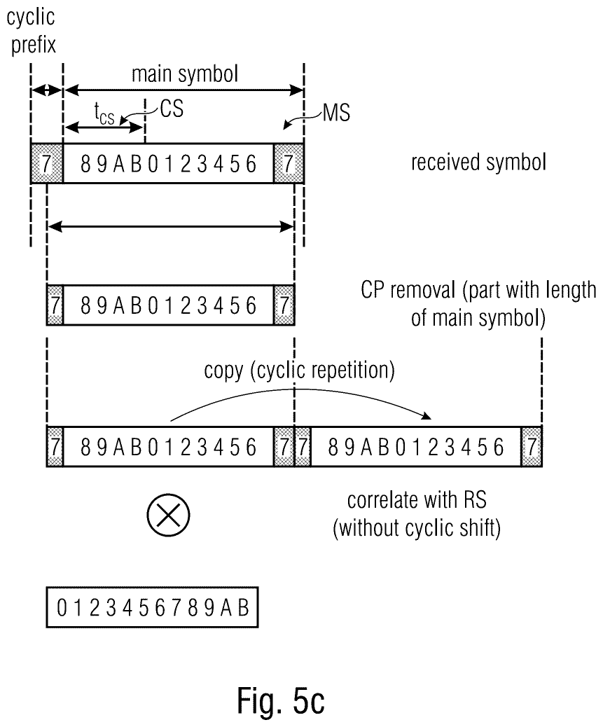

5G networks support “multiple access” per OFDM symbols. An OFDM symbol includes several resource elements (REs). Several UEs may use the same OFDM-Symbol for transmission, but may use different REs. Each RE may be mapped to a subcarrier of the OFDM symbol. To maintain the orthogonality between the subcarrier the signals of different UEs have to arrive at the receiver with limited time offset. The allowed uncertainty depends on the cyclic prefix length. To ensure that the signals of different UEs arrive within this uncertainty the network configures a time offset (“timing advance”=TA) relative to the symbol timing recovered from a downlink signal. For time of arrival measurements, a correlator may be used. The input to the correlator may be the received data within a time interval (“window”) and the reference signal. The correlator measures typically the time relative to the “window start”. For the cyclic correlator the window length is identical to the FFT length (=OFDM symbol without CP). The principle of a cyclic correlator is depicted in FIG. 5c. If performed in the time domain two replica of the signal in the window with the length of the main symbol (equivalent to the FFT length) may be combined to a vector of double length vector and a cross correlation with the reference signal is performed. For other correlators the window length may be different, but in this case the subcarriers are no longer orthogonal and ICI (inter carrier interference) may degrade the performance.

The window start may be selected according to tolerances for nonideal TA settings and expected “channel excess delay” (=delay of the latest (relevant) multipath component). For ideal TA the optimal window position is “end of CP” (cyclic prefix). This minimizes the ISI (inter symbol interference). But other positions are also possible. In FIG. 5c the window covers parts of the CP and ignores parts of the end of the main symbol. The effective ToA and ToT ((time of transmit) is typically the time offset of the OFDM symbol relative to the “OFDM window” plus the time stamp of the window start. For ideal symbol timing recovery and ideal TA setting the uplink signal arrives synchronous to the framing of the network and the measured delay relative to the window start may be zero. Ideal symbol time recovery and ideal TA setting means for TDD it is assumed that the TX and RX framing of the gNB is aligned (for FDD an offset is not critical, but the framing may be still aligned or at least the signals received from several UEs are aligned). The OFDM symbol framing of the UE is delayed by ToF (time of flight) relative to the gNB OFDM symbol framing. The TX framing of the UE is set relative to the recovered RX framing. To ensure that the UL signal arrives aligned with the gNB DL/UL framing the nominal value (ideal) of the TA is 2*ToF. The TA is configured by the gNB. An ideal symbol time recovery and ideal TA setting is considered as not feasible (if feasible the TA value is already identical to the RTT, at least for TDD (for FDD the gNB offset between TX and RX framing has to be taken into account). The RTT procedure takes into account non-ideal TA settings or non-ideal OFDM symbol timing recovery by the UE.

Starting from this procedure, the RTT procedure can be described as follows: The gNB calculates the difference between t₄ (time-of-arrival (ToA) of the UL signal) and t₁ (time-of-transmit (ToT) of the DL signal. The UE measures (or sets) the difference between t₃ (time-of-transmit (ToT) of the UL signal) and t₂ (ToA of the DL-signal). “Measure” means: The difference ToA, DL and ToT, UL are measured with a resolution better than the sampling interval (T_{S}). “Set” means: ToA, DL is measured with a resolution better than T_{S}. The difference may be quantized (e.g. to T_{S} value, where T_{S} is the sampling time interval according a nominal sampling frequency). The resulting ToT, UL may be no longer aligned with the sampling grid and a “resampling” of the uplink PRS may be needed. If the (t₃−t₂) is set the TA has to be considered. From this two values the ToF (time-of-flight=distance/speed_of_light) can be calculated

$$ToF = ( ( {t}_{4} - {t}_{1} ) - ( {t}_{3} - {t}_{2} ) ) / 2$$

This principle works also for non-ideal TA settings. The measured ToA relative to the gNB framing (t_{4,rel} is the t₄ measured relative to the OFDM symbol timing of the gNB) may be also an indicator for non-ideal TA setting and needed TA adjustments. To ensure an arrival of the UL signal inline with the gNB framing with an “ideal” TA setting (measured would be t_{4,rel}=0 in this case) results in

$${t}_{3} - {t}_{2} = k * {t}_{Sym} - 2 * ToF$$

wherein k takes into account that the signal is transmitted in another slot or OFDM symbol. Non-Ideal TA setting results in t_{4,rel} different from 0

Starting from this procedure, the concept according to embodiments improves the exchange of the reference signals (first reference signal transmitted externally from the UE and second transmit signals transmitted from the UE to external) is improved. The improvements are mainly focused on improvements with regard to the reporting or the need for reporting.

An embodiment of the present invention provides a transceiver, e.g., a transceiver UE exchanging reference signals externally, e.g., with a base station or another UE. In the schematic diagram of FIG. 4, the steps performed by the UE 12 comprising the transceiver are illustrated in the lower row, wherein the external entity 10 and the respective steps are illustrated in the top row. The external entity 10 is referred to as TRP (transmission point), wherein a person skilled in the art would interpret this term as a synonym for a (/another) UE comprising a transceiver or a base station comprising a transceiver.

The UE 10 is configured to receive and transmit signals, especially reference signals RS1 and RS2. Here, a first reference signal RS1 is referred to as DL symbol (downlink symbol) wherein a second reference signal RS2 is referred to as UL symbol (uplink symbol).

The UE 12 is configured to receive the first reference signal, also referred to as DL symbol at a second point of time t2. This first reference signal RS1/DL symbol is transmitted by the transceiver 10 at a first point of time t1. This means that a transceiver is configured to determine the second point of time/time of arrival. This may be done by a measurement so as to determine the second point of time.

In response to the receipt of the first reference signal RS1/DL symbol, the transceiver 12 transmits a second reference signal RS2, also referred to as UL symbol. The transmission is performed or started at a third point of time t3, but with a modified symbol. In detail, the content of original first sample (0123456) of the second reference signal RS2 is transmitted at the fifth point of time, wherein the end of the sample is added at the beginning of the transmitted main symbol and the cyclic prefix (CP) may now include different data. The modified symbol is transmitted at t3.

The modification of the content of RS2 is done as follows: The second reference signal is modified by a so-called cyclic shift, so that a transmission of OFDM symbols 012345 may be postponed to the fifth point of time so that a correlation to this symbol order would determent the correlation peak postponed/delay/shifted with respect to t3. (see FIG. 5c). Consequently, the fifth point of time t5 may be later than the third point of time t3. The cyclic shift CS is defined by a so-called cyclic shift value t_{CS}.

According to embodiments, the cyclic shift value t_{CS} is derived from the second point of time of the received first reference signal and a time information associated with the fifth point of time t5. According to embodiments, the second point of time may be measured, e.g., using a typical time of arrival (ToA) measurement. The time information associated with the fifth point of time may, for example, comprise a desired duration between the second point of time and the fifth point of time. The value may be set by the network or can be derived from other configuration parameters. For example, the duration of the time interval may be calculated based on the formula t₅=t₂+n*t_{Sym}−TA. Here, TA is the timing advanced value, which is typically set by the network or remains constant until updated (semi persistent). “n” can be derived from the scheduling of the OFDM symbol configured for the uplink signal relative to the OFDM symbol used for the downlink reference signal. Thus, the formula fulfills the above-discussed requirements for deriving the cyclic shift value based on the second point of time t2 of the received first reference signal and a time information associated with the fifth point of time t5.

In other words: the third point of time t3 may represent a time of the first sample of the modified OFDM symbol, wherein the modification results in an effective point of time defined by the fifth point of time t5. According to embodiments, the transmitter is configured to calculate the fifth point of time dependent on the second point of time and a cyclic shift and/or based on a desired duration between the third point of time and the second point of time, wherein the third point of time is set according the synchronization requirements (TA setting).

The correlation peak of second reference signal RS2/UL symbol transmitted by the user equipment 12 is then detectable at a sixth point of time t6 by the other transceiver 10. Consequently TRP 10 would determine t6 as time of arrival (ToA). Note, this sixth point of time is different from a fourth point of time t4 representing ToA in which the second signal would be detect if a signal without cyclic shift is transmitted (cf. point of time t4 as discussed in the context of FIG. 4). In the same way, the fifth point of time is different from a third point of time representing the time window in which the second signal would be transmitted without cyclic shift, e.g., postponed by the cyclic shift with respect to the third point of time.

Applying the cyclic shift has two main advantageous:
1. for the example of two UEs (UE₁ plus UE₂ or TRP plus UE₂) it is possible to use low power reference signals and to perform the RTT measurement without any reporting, since the time difference t5 to t2 can be maintained as constant. Thus, —according to embodiments—a time of flight and/or round trip is calculable based on a difference between the sixth and the first point of time taking into account a desired (constant, known, defined) duration between the second and the fifth point of time.
2. for the example of a plurality of UEs (UE₁ plus UE₂a, UE₂b, . . . or TRP plus UE₂a, UE₂b, . . . ) it is possible to use different cyclic shifts for the different UEs to enable a distinction.

Regarding the reference symbols it should noted that the first reference symbol RS1 received at the second point of time t2 may comprise a predetermined time reference point OFDM symbol with cyclic prefix. As discussed above, the first reference signal may comprise an initiator signal initiating a position measurement.

Starting from this, the following method may be summed up. According to embodiments, the goal is to make the difference between the effective ToT (time of transmit) relevant for positioning/ranging measurements independent from the ToT set according to network symbol timing requirements, wherein the effective ToT is considered as time related to the detected ToA of the receiver and the difference between ToT and ToA represents the time-of-flight (ToF). In the following the following nomenclature is used:
t1 is the ToT of the DL signal transmitted by a first device
t2 is the ToA measured by the second device (e.g. UE)
t3 is the time set according the network symbol timing requirements
t4 is the time when the UL signal arrives at the first device.
t5 is an effective ToT resulting by modifying the transmit symbol by cyclic shift
t6 is the detected ToA assuming a cyclic correlation of the received signal with the (not shifted) reference signal.

It should be noted in the context of the application, examples are provided for sidelink or Uu applications. The proposed method is applicable for any two or more ranging devices, wherein the first or the one or more second devices, unless explicitly mentioned, can be a UE, TRP, BS, NTN BS, NTN UE, RSU (Road side unit), PRU (positioning reference unit) or the like.
This implies that
   t₁, t₄ and t₆ are measured or set using the clock of the first device (network device or a first UE)
   t₂, t₃ and t₅ are measured or set using the clock of the second device (e.g. UE)
   The second device may recover the clock by performing measurements (e.g. detection of synchronization signal) on the signals transmitted by the first device (gNB, for example)
To maintain the timing constraints of the network (or the other receiving device) t₃ is set accordingly (for example by adjusting a TA)
t₅ is calculated according the measured t₂ and the desired (t₅−t₂) difference.
Using a cyclic shift the effective correlation peak moves, but the TA can be still maintained. This allows to make t₃ and t₅ different
   t₅ is used for the reporting of the difference t₅−t₂ (instead of t₅−t₂)
   t₃ is set according to TA requirements.
This allows to set the difference (t₅−t₂) to a desired (constant) value.
The difference between t₃ and t₅ is implemented as cyclic shift.

$${t}_{CS} = {t}_{5} - {t}_{3}$$

If the difference t₅−t₂ can be set to a desired value the reporting of the difference is simplified
   A constant value is used and for example configured together with the RS configuration.
   The desired difference is derived from parameters known at both UE and gNB (e.g. OFDM symbol parameter setting).

For example, the proposed solution is applicable in a number of different scenarios, where the terminology responder for the device that responds according to t₅. According to an embodiment, the network may configure the desired (t5−t2) difference. For example, the UE derives t₃ (=time of the first sample of the OFDM symbol) from the recovered OFDM symbol timing and the TA setting t₅ is calculated according the measured t₂ and the desired (t₅−t₂) difference. The difference between t₃ and t₅ is applied as cyclic shift to the reference signal. For the selection of the desired t₅−t₂ difference different methods can be considered: A fixed value is selected independent from TA. The value is selected that the difference between t₅ and t₃ is covered by the supported CS range. Otherwise, a modulo operation may be used as described below and an ambiguity may result. In case of COMB structure an additional ambiguity may result. To avoid the ambiguity the CS range may depend on the COMB factor also. If only one OFDM symbol is used the CS-Range in samples is the CSₛₐₘₚₗₑₛ=FFTlength/COMB_factor and in time t_{CS,max}=CSₛₐₘₚₗₑₛ/fs. As mentioned above the nominal difference with ideal TA is t3−t2=k*t_{Sym}−2*ToF. “k” is known from the scheduling of the signal transmissions (=configured position of the RS in the frame) 2*ToF can be replaced by the known TA resulting in

$${t}_{3} = {t}_{2} + k * {t}_{Sym} - TA$$

Hence the difference t₃−t₂ is k*t_{Sym}−TA and known at UE and gNB (assuming TA is signaled as value and not adjusted by a loop implementing an adjustment by “increment/decrement” of TA until the symbol arrives at the desired time. In this case the TA value may be known by the UE only. Furthermore it is not necessary to derive t3 from t2. t3 can be also derived from other synchronization signals (e.g. SSB).

In all cases the needed cyclic shift can be derived from the configured t5−t2 difference and the calculated t3. t2, t3 and t5 are measured (or set) relative to the clock of the UE. The clock of the UE may be derived from the network clock and may have a (small) offset according to limited synchronization accuracy.

If the UE responses to a gNB different from the serving-gNB (neighboring-gNB=n-gNB) the n-gNB may not know the TA setting relative to the s-gNB. For transmissions toward the n-gNB the UE may use the same framing as for transmissions toward the s-gNB or may re-adjust the framing according a TA-value applicable for the n-gNB or a default TA setting.

Regarding the second reference signal UL symbol, it should be noted that same is received by another transceiver 10, which can perform a ToA measurement based on cyclic (cross) correlation with the configured (unmodified) transmitted reference signal resulting in the sixth point of time t6. Below, the correlation will be discussed in detail together with other details for the above-discussed method. Note, all below-discussed details are optional features according to further embodiments. FIG. 5 depicts the principle of the time-of-arrival measurements for OFDM signals with cyclic prefix and cyclic correlation. We assume the transmitted signal is a OFDM symbol with cyclic prefix (CP). The CP is a copy of the last part of the transmit signal. A possible implementation of the cyclic correlation is
The cyclic correlation uses the “main part” of the OFDM symbol as input. The OFDM symbol timing of the received signal is recovered and a “window” according the FFT length is determined. The samples within the window are used for further processing. Without multipath propagation the window can start at any position within the CP. With multipath propagation the window typically starts at the end of the CP.
The samples within the window are transformed into the frequency domain using an FFT.
The receiver knows the transmitted reference signal (RS) or the FFT of it (frequency domain representation of the RS)
In the frequency domain the received signal is multiplied with the complex conjugate of the transmitted RS. The result is the estimated frequency response of the channel.
The inverse FFT of the frequency response is the “cyclic correlation” in the time domain.
The cyclic correlation represents the channel impulse response folded with the sin (x)/x function according to the used bandwidth of the RS
If the RS has good auto-correlation properties the position of the correlation peaks represent the Time-of-Arrival (ToA) relative to the time of the first sample of the window. Together with the time of the first sample of the window the ToA can be estimated.
Beside the ToA of the first arriving path it may be also possible to estimate the ToA of multipath components.

As can be seen with respect to the comparison of the FIGS. 5a and 5b, the cyclic shift CS modifies the OFDM symbol with cyclic prefix. FIG. 5a shows the original OFDM symbol having a main symbol MS and a cyclic prefix identical to part “B” of the main symbol. Starting from the cyclic shift CS defined by the cyclic shift value t_{CS}, the main symbol MS is shifted, and a new CP is generated after cyclic shift CS of the main symbol MS. The last part of the symbol, here the seventh, is copied to the beginning and used as cyclic prefix. The result of the cyclic correlation is illustrated in the respective second diagram of FIG. 5 (FIG. 5b). According to FIG. 5a, the cyclic correlation would determine the correlation peak related to the first arrival path at position ToA (time of arrival). Starting from modified OFDM symbols according to embodiments of the present invention (cf. FIG. 5b) the output of the cyclic correlation would deliver different detected ToA's, e.g., postponed by t_{CS}. Note, the correlation is performed with the non-shifted reference signal.

The cyclic correlation can be also calculated in the time domain. In this case the two replica of the signal within the window are concatenated and cross correlated with the reference signal (FIG. 5c). Alternatively two replica of the reference signal are concatenated and correlated with the signal received in the time window.

It is possible to apply a cyclic shift to the RS before transmission. The cyclic shift is applied to the main symbol before CP insertion. If the cyclic shifted RS is correlated with the (not shifted) RS the ToA relative to the window start (ToAᵣₑₗ) is detected at a position according the applied cyclic shift (cf. FIG. 5b). The cyclic shift can be also negative. Due to the cyclic behavior of the cyclic correlation the detected ToAᵣₑₗ will be

$${ToA}_{rel} = {ToA}_{rel , Sym} + mod ( {t}_{CS} , {t}_{Sym} )$$

Wherein
   ToA_{rel,Sym} is the ToAᵣₑₗ of the symbol without cyclic shift. This part covers offsets from non-ideal OFDM window recover
   t_{CS} is the cyclic shift applied to the RS
   t_{Sym} is the length of the main part of the symbol (symbol length without CP)
   mod( ) is the modulo operation.

Together with the time stamp of the first sample of the window the ToA of the RS can be calculated

$$ToA = {ToA}_{rel} + {t}_{WindowStart} .$$

As discussed above, this leads to the situation that the second reference signal transmitted at the third point of time and received at a fourth point of time is transmitted, such that the ToA for the cyclic correlation is measured at a sixth point of time. In other words, this means that such a reference signal is to be received by a receiver or another transceiver forming a ToA measurement based on a cyclic (cross) correlation of the received signal with the configured (or modified) transmitted reference signal resulting in a sixth point of time and the difference between a sixth point of time and the fifth point of time represents the time of flight. Here, the first OFDM main symbol is transmitted at the point of time t₅ (fifth point of time). Note, the cyclic shift value derived from the second point of time t₂ is also derived from a time information associated with this fifth point of time t₅. For example, this time information may be described by the value t_{CS}. In other words, this means that at the sixth point of time a start of the OFDM symbol ToA′ of the reference signal RS is detected by a receiver or another transceiver assuming the cyclic relation, wherein the sixth point of time is different from a fourth point of time representing the time window in which the start of the OFDM symbol of the second reference signal would be received without cyclic shift. According to embodiments, the difference between the fourth point of time and the sixth point of time depends on the applied cyclic shift, wherein this difference is not known at the receiver and/or not required for further processing. Note, the difference between the sixth point of time and the related fifth point of time represents the time of flight (ToF) between the transmitter and the receiver.

This relationship will be discussed in detail taking reference to the above-mentioned FIG. 4 showing an example of how to apply cyclic shift for RTT measurements to avoid reporting of the difference “dt32” between t₃ and t₂.
It is assumed the UE is synchronized (OFDM symbol timing is recovered with an acceptable accuracy, the frequency offset of the UL and DL are within a feasible tolerance) to the DL signal and the network has adjusted the needed timing advance (TA). The timing advance adjustment may be non-ideal (e.g., adjusted only according to a measurement with limited accuracy) or set to a default value.
According the recovered OFDM framing, the configured resources (slot number and OFDM symbol index within the slot) and the TA setting the UE can calculate the t₃. representing a transit time where the signal would arrive at the gNB inline with network synchronization requirements.
If the UE receives a DL symbol (DL-RS) suitable for high accuracy ToA measurement (a DL-PRS, for example) the UE can determine t₂ by measuring the ToA of the DL-RS.
The network may configure a desired difference dt₅₂ between the effective time-of-transmit (t₅) and the estimated ToA of the DL-RA (t₂).

$${t}_{5} = {t}_{2} + {dt}_{52}$$

t₅ may be different from t₃. Instead of readjusting t₃, which may violate network symbol timing requirements a cyclic shift can be applied to the RS transmitted by the UE. This maintains t₃. The needed cyclic shift is

$${t}_{CS} = {t}_{5} - {t}_{3}$$

The difference between t₅ and t₃ can be only compensated by cyclic shift, if the calculated t_{CS} is greater or equal 0 and less the t_{Sym}, wherein t_{Sym} is the duration of the main part of the OFDM symbol. If the calculated t_{CS} exceeds this range a modulo operation can be applied

$${t}_{CS} = mod ( {t}_{5} - {t}_{3} , {t}_{Sym} )$$

In this case the receiver should take into account the ambiguity. Typically, the symbol duration is much greater than the ToF. Hence the ambiguity can be resolved easily.
t₃, t₅ and t₂ are measured relative the UE clock. Only the differences between the values are relevant. Hence, the concept works also, if the UE clock (“time”) has an offset to the network time.

According to embodiments, the second reference signal is modified by a cyclic shift, namely in that way, that the OFDM symbol is cyclically shifted (FIG. 5a and FIG. 5b shows the principle part “89AB” is copied to the beginning and part “01234567” is moved to the end) before cyclic prefix insertion, wherein the cyclic prefix is a copy of the end of the OFDM symbol (cf. number 7 of the OFDM symbol out of FIG. 5b).

According to embodiments, the cyclic shift to the RS can be applied by different methods.
The cyclic shift is applied in the time domain (see FIG. 5c).
The cyclic shift is applied in the frequency domain

If the cyclic shift is an integer multiple of the sampling period used a cyclic shift can be implemented by reordering the samples of the vector in the time domain. The calculated needed cyclic shift is typically not an integer multiple of the sampling period. Hence, it may be more efficient to apply the cyclic shift in the frequency domain. A cyclic shift in the frequency domain can be implemented by

$${S}_{( n )} = {R}_{( n )} \cdot {e}^{j α n}$$

with

$$α = \frac{2 π {t}_{CS}}{{T}_{0} N}$$

wherein
   N FFT length
   n Index, n∈[0, (N−1)]
      R₍ₙ₎ frequency domain representation of the RS without cyclic shift. R₍ₙ₎=fft(r₍ₙ₎), r₍ₙ₎ is the time domain signal of the RS without CP)
      t_{CS} is the target cyclic shift (in seconds)
      T₀ is the sampling period in seconds
      S₍ₙ₎ is the frequency domain representation of the RS with cyclic shift.

According to embodiments, the cyclic shift performed by the transceiver 12 as it is illustrated by FIG. 4 can be performed in two different ways, namely dependent on a cyclic shift applied in a frequency domain or the time domain.

In the frequency domain, two vectors of same lengths are multiplied in a frequency domain, e.g., using an FFT. The result is an information regarding the phase, wherein the edge steepness gives an information on the delay between t₄ and t₆.

In the time domain, the used signal, here the received reference signal, is repeatedly concatenated (FIG. 5c), so that by use of a cross correlation, the beginning of the modified OFDM symbol (cf. reference numeral ToA′) can easily be determined.

As discussed above, the modification is performed based on the cyclic shift, wherein the cyclic shift is defined by the so-called cyclic shift value. This cyclic shift value may be derived out of a time information associated with the fifth point of time. According to embodiments, this time information may comprise a desired duration between the fifth point of time and the second point of time, i.e., the information including t_{CS} and the duration t₃ to t₂. According to embodiments, the difference between the fifth point of time and the third point of time represents the needed cyclic shift value directly, wherein the third point of time is selected according to the network synchronization requirements and the scheduling of the second reference signal. The synchronization requirements may be defined relative DL synchronization signals such as SSB, DL-PRS, CSI-RS and adjusted by the network by configuring the TA or using a default value for TA. It should be noted that according to embodiments, the cyclic shift value may be set to zero, so that no cyclic shift is performed. When according to embodiments, only the cyclic shift value is defined as t_{CS}, the third point of time can be derived from the measured second point of time with

$${t}_{3} = {t}_{2} + {t}_{TX} - TA ;$$

where t_{TX} represents the scheduling of the OFDM symbol in which the second reference signal is transmitted relative to scheduling of the first reference signal, TA is the set by the network or remains constant until updated (“semi-persistent”).

Note, the desired duration between the fifth point of time and the second point of time is constant or semi constant (constant for a configurable number of transmissions or durations) or derived from another parameter, such as transmitter ID. According to embodiments, the designed duration is configured or preconfigured. According to further embodiments, the (needed) cyclic shift value is calculated from the difference between the fifth point of time and the third point of time by

$${t}_{CS} = {t}_{5} - {t}_{3}$$

$$or$$

$${t}_{CS} = mod ( {t}_{5} - {t}_{3} , {t}_{Sym} )$$

if the difference t₅−t₃ is less than 0 or greater or equal t_{Sym} wherein t_{Sym} is the duration of the OFDM symbol without cyclic prefix.

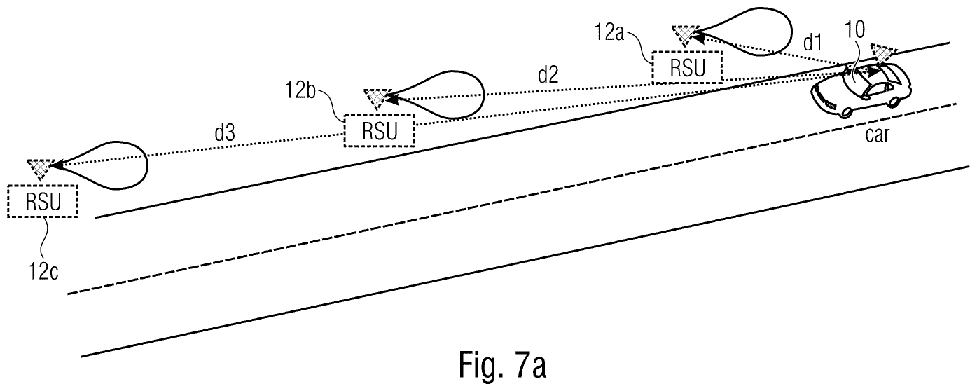

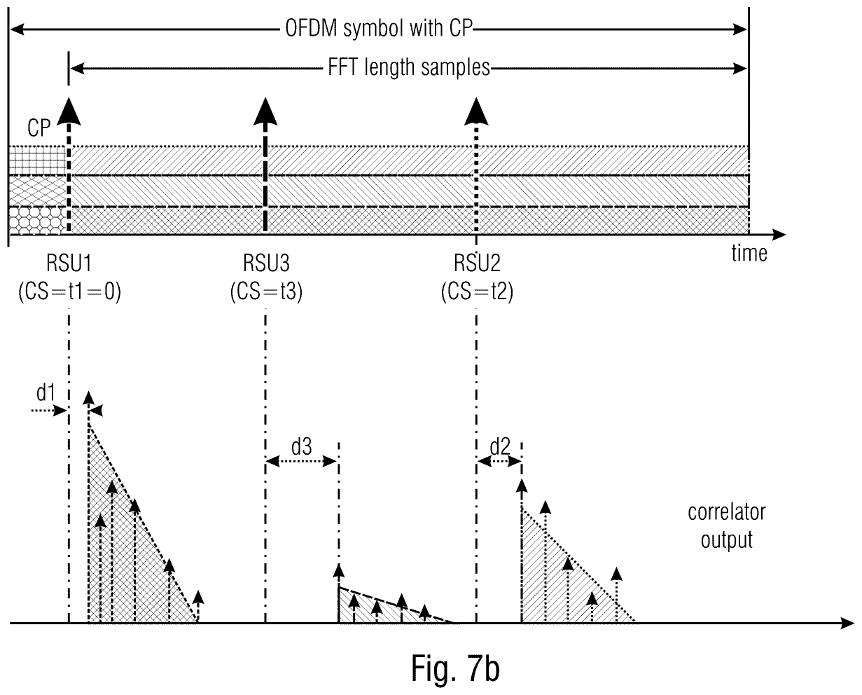

According to further embodiments, the transceiver may be configured with a second cyclic shift value or the second cyclic shift value is derived from other configuration parameters, such as the antenna port, wherein the second cyclic shift value is added to the first cyclic shift value; and/or wherein the second cyclic shift value is coded differently when compared to the first cyclic shift value. For example, the different cyclic shift if used for different second reference signals to be transmitted to different or other transceivers. The background thereof will be discussed with respect to FIG. 7a, where a plurality of transceivers (roadside units (RSU), for example) are exchanging communication signals/reference signals with another transceiver (e.g. a car). The car may be the initiator and the RSUs the responder. Thus, this means that according to embodiments several transceivers (responder) may use the same resources in the time and frequency and the desired difference between the fifth point of time and the second point of time is configured differently. For example, different cyclic shifts are configured for the different transceivers of the several transceivers resulting in several correlation peaks representing the sixth point of time for each of the transmitted signals to the respective one of the several transceivers. Note, the configured value is selected allowing an assignment between the correlation peak to the related transceiver. According to embodiments, several transceivers may respond to a first reference signal transmitted by another transceiver which forms an initiator. The cyclic shift depends on responder specific information or responder/anchor ID information. consequently, the cyclic shift value may also be derived from the first reference signal.

According to embodiments, the UE is configured to receive a configuration message, e.g., from the network or the other device (in case of sidelink). Based on this configuration message the cyclic shift value is set. For example, the configuration includes information for the selection of the CS value or range/interval. The CS value may be dependent on responder specific information or responder/anchor ID. The configuration includes information to validate the estimated needed CS value. According to embodiments the UE may receive this configuration in the first step so that the RS signal from the other device can be received in the second step. After that, the configuration message is applied to derive the CS value. Note, this configuration message represents the time information associated with the point of time. As discussed above, the signature values derived from this configuration message/time information associated with the fifth point of time taking into account the measured second point of time (measured time of arrival) as reference. As discussed above, this reference signal may also include information influencing the CS value. After that, the RS2 is transmitted with the selected CS value.

Note, according to embodiments, different reference signals may be used as the first reference signal. For example, a synchronization or reference signal such as the SSB, CSI-RS or DM-RS may be used.

Note, according to embodiments the third point of time and the desired duration is derived from parameters known at the transceiver, i.e., preconfigured, and the other transceiver. The information relating to the difference between fifth and second point of time is available at the transceiver and the other transceiver as well. According to embodiments, the time information associated with the fifth point of time comprises configuration information for the selection of the (second) cyclic shift. This second cyclic shift may be used for another transceiver.

Regarding the information relating to the fifth point of time, it should be noted that same comprises definitions for two values, especially a value for the timing advance and an OFDM symbol timing to maintain the time constraints. Note this is an information used for determining the third point of time. According to embodiment, the information relating to determine the third point of time may be preconfigured or received from the network, the gNB or a localization server. Note, the third point of time depends on a system timing constraint or is set according to timing advanced constraints. According to embodiments, the third point of time is derived from recovered OFDM symbol timing and timing advance settings.

According to an embodiment, a localization node, like a location server, location management function (LMF) or a local location function at transceiver (10) or a BS or RSU, is provided. It is configured for: requesting a measurement report from transceiver (10); receiving an information on a time of arrival measurement for the second reference signal (RS2) from the transceiver (10); and calculating a range between transceiver (10) and transceiver (12) based on the received measured time of arrival from transceiver (10) and information on the third or fifth point of time (t5).

According to further embodiments, a transceiver (10) is configured to calculate a time of arrival of the second reference signal (RS2) based on a measurement performed by another transceiver (10) or to perform a measurement of a time of arrival of the second reference signal (RS2); and to calculate and/or report a range based on the calculated or measured time of arrival based on an information on the third or fifth point of time (t5) without receiving or accessing a measurement report from the transceiver (12) transmitting the second reference signal (RS2).

According to embodiments, the first and/or second reference symbol is configured by the network or a transceiver with respect to one of the following factors: position in frame, slot number and OFDM symbol position in slot, number of OFDM symbols used for the RS, RS sequence type and RS sequence parameter, bandwidth, center frequency, COMB factor, sequence ID, etc.

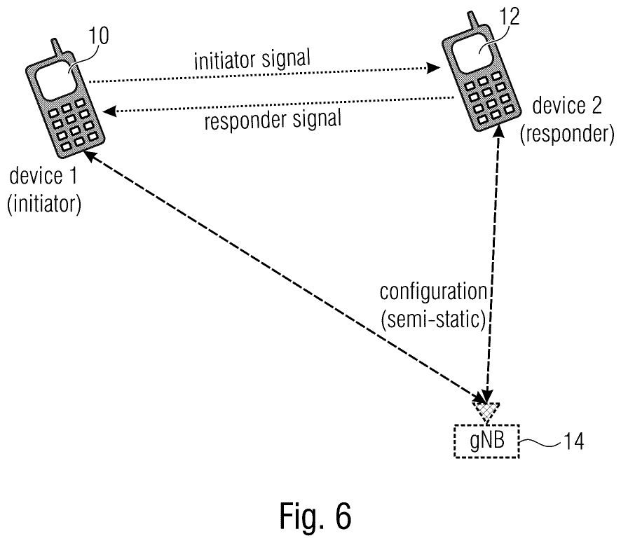

With respect to FIG. 6, a device-to-device round trip measurement (one initiator and one responder) may be discussed. The devices are marked by the reference numerals 10 and 12, wherein 10 is the initiators and 12 the responder. Both communicate with a gNB, e.g., for receiving the configuration wherein the configuration may be “semi static” or valid for a configurable duration. The gNB is marked by the reference numeral 14.

The two devices 10 and 12 perform RTT measurements by transmitting from a first device (Initiator) a RS to a second device and the second device responses with a RS transmitted toward device 1.
The network (or a first device in case of sidelink operation) configures the RS (position in frame (slot number and OFDM symbol position in slot, number of OFDM symbols), RS parameters (bandwidth, center frequency, COMB factor, number of symbols, sequence ID, etc.).

The configuration may be
semi-persistent or
configured in advance and the RS is activated by triggering or
configured in advance and activated if a predefined condition becomes valid (e.g. the responder detects the signal from the initiator).
The configuration information may include a TA setting. This TA defines the transmit time t₃ relative to the recovered OFDM symbol framing.
The network configures a constant response time for device 2.
The initiator transmits a reference signal.
The responder performs ToA measurements on the signal received from the initiator.
From the measured ToA the responder calculates an effective transmit time t₅.
Using the transmit time according the TA setting (t₃) the responder calculates a cyclic shift t_{CS}=t₅−t₃ and applies this cyclic shift to the configured RS before transmitting the RS at the time t₃.

According to further embodiments, one initiator and several responders may be used. This is shown by FIG. 7a.

The initiator UE is marked by the reference numeral 10, wherein the responder UEs are marked with the reference numerals 12a, 12b and 12c. Note, here the UEs might be model UEs, like cars or general RSUs (road side units). Thus, one signal per transmitter is transmitted (equal “on-air multiplex”) wherein CS-MOX is used for the answer. This embodiment is characterized by the following steps:
One initiator (e.g. a moving device).
The signal transmitted by the initiator is received by several (k) “responders”.
Each responder may use the same resources for the response or different resources (e.g. different COMB offset or different OFDM symbol).
If the signals use the same resources the signals of the responder are distinguished by
   Using different cyclic shifts (“cyclic shift multiplex”=CS mux)
   Alternatively: using different sequences (“code multiplex”)
Each responder calculates a CS (in case of CS mux a second CS) to adjust the effective ToT (t_{5,k}).
The initiator receives several responses and can calculate the distance to each responder.
If the position of the RSU is known, the initiator may be able to calculate its position or range relative to the RSU or several RSUs.

According to embodiments, this means that the first reference signal as sent by an initiator 10 comprises an initiator signal initiating a position measurement. Furthermore, the differential cyclic shifts may be used by the transceiver (responder) for the response signal (second reference signal, third reference signal, . . . ).

The embodiments as discussed with respect to FIGS. 6 and 7 have shown that the discussed principle may be used for sidelink communication and, thus, for the position determination in the sidelink. Advantageously, but not necessarily, configuration information from a gNB or a localization sever may be used. However, this configuration information may also be preconfigured according to further embodiments.

According to embodiments, all RSUs 12a, 12b and 12c may use the same resources (same REs) and transmit at nearly the same time using the same OFDM symbol. Each RSU selects also the same sequence, but applies different cyclic shift (CS) to the symbol. This shifts the correlation peak in time, if the sequence is correlated with the (not shifted) sequence.

If the RSU use the same REs the signals will superimpose and the correlator output includes several peaks.

This is illustrated by FIG. 7b. In the example of FIG. 7b it is assumed that three road side units with different distances to the UE 10 (cf. FIG. 7a) are used. Assuming the RSUs are synchronized to the network and transmit the signals nearly at the same time but each RSU uses a different CS. The signals will arrive with a time offset according the different distances d1, d2 and d3. Multipath propagation is assumed. Hence, after the first arriving path (FAP) several multipath components may arrive. The correlator output will include correlation peaks related to each RSU and related multipath components (indicated as triangle and additional correlation peaks in the figure. The parts of the correlation function related to the different RSUs are marked with different colors. The positions of correlation peaks depend on the distance and the configured CS for each RSU there are two implementations possible:
Each RSU k reports the t₅-t₂ difference. This is not in the scope of the invention.
Each RSU k is configured with a first CS1 and calculates a second CS2 according the measured t_{2,k} and the desired t_{5,k}
The t_{CS2,k}=t_{5,k}−t_{2,k}−t_{CS1,k}−dt_{const}
with
   t_{2,k} is the measured ToA of RSU k
   t_{CS1,k} is the configured CS1 for RSU k
   dt_{const} is a configured time offset (n*t_{Sym}−TA, for example).

Alternatively the t_{CS2,k} can be calculated by

$${t}_{CS2 , κ} = {t}_{5 , κ} - {t}_{3 , κ} + {t}_{CS 1 , κ}$$

with
   t_{3,k} is the configured transmit time according the network symbol timing
   requirements.

Due to the CAZAC (constant amplitude zeros auto correlation) properties of the Zadoff-Chu sequences used for a SRS the signals can be distinguished even if received with a high level difference. For the evaluation of the feasibility and the signal requirements we consider a numerical example.

| | RSU1 | RSU2 | RSU3 |
|---|---|---|---|
| Distance RSU ⇔ car (UE) [m] | 10 | 500 | 1000 |
| Pathloss (freespace) [dB] | 63.3 | 97.3 | 103.3 |
| (3.5 GHz) | | | |
| Transmit power [dBm] | 0 | 0 | 0 |
| (assuming “broadcast”, same | | | |
| EIRP for all RSU) | | | |
| Assumed UE antenna gain [dB] | 0 | 0 | 0 |
| SNR (in effective bandwidth), | 27.6 dB | −6.4 dB | −12 dB |
| assumed bandwidth 100 MHz, | | | |
| NF = 8 dB | | | |
| Level difference (relative to | Ref (0) | 34 | 40 |
| strongest signal), no shadow | | | |
| fading, free space propagation | | | |
| conditions. | | | |

Especially in this embodiment, it might be possible that the RSU will be configured on which sequence ID the RSU will provide a response. For example, the UE receives assistance data on which initiator signals an RSU should respond.

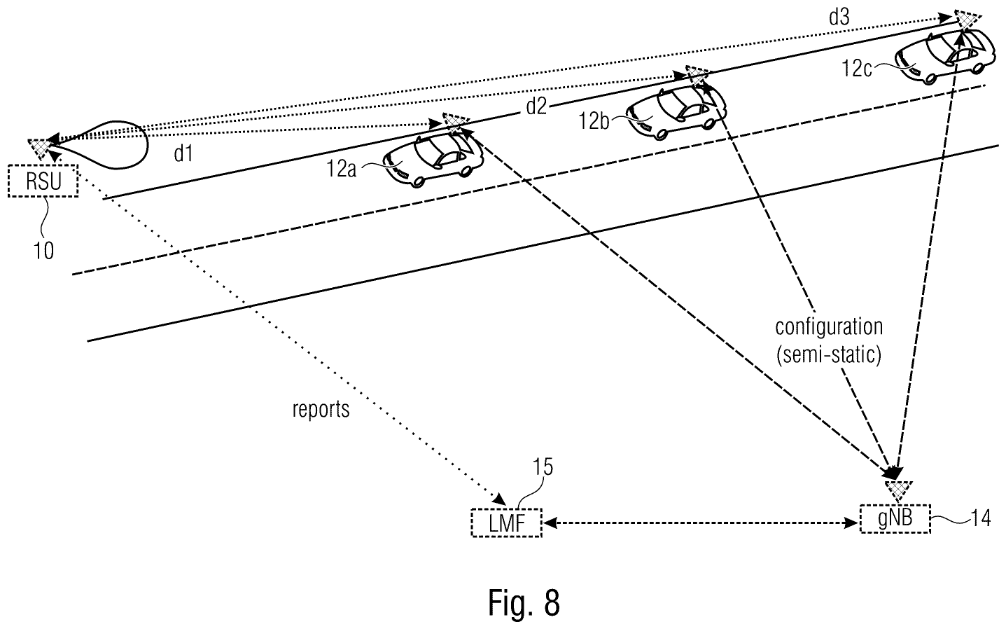

With respect to FIG. 8, the usage of CS-Mux for the answer will be discussed. FIG. 8 shows an initiator UE 10 which is here a road side unit, which transmits a signal to several other UEs 12a, 12b and 12c. The signal transmitted by the initiator is received by several (k) “responders” (e.g. UEs in cars).
Each responder uses the same resources for the response.
The signals of the responder are distinguished by
   Using different cyclic shifts (“cyclic shift multiplex”=CS mux)
   Alternatively: using different sequences (“code multiplex”).
Each responder may be configured using a different CS1
Each responder calculates a CS2 (in case of CS mux a second CS) to adjust the effective ToT (t_{5,k}).
The initiator (e.g. RSU) calculates the ranges and may report the ranges to the network (LMF)

This means that according to embodiments, the first reference signal is transmitted as an initiator signal, here by the transceiver 10, wherein the plurality of transceivers receiving the first reference signal transmit their respective second reference signal using different cyclic shifts defined by different cyclic shift values. Consequently, by use of CS-Mux for the answer, the response includes the sum of several signals, the signals with different cyclic shifts only. Alternatively, different sequences or resources are used as an answer for the initiator.

Regarding the LMF entity it should be noted that this LMF/local positioning server may, according to embodiments, calculate the position as follows:
Requests a measurement report from at least one initiator; and
Receives a ToA (or Rx-Tx time difference) measurement from the initiator,
DO NOT receive a measurement report from the responder;
And calculate the range based on the measured ToA and information of the responder transmission time.

Analogously, the position determination may be performed by the initiator entity as follows:
calculates a ToA (or Rx-Tx time difference) measurement from the initiator,
DO NOT receive a measurement report from the responder;
And calculate the range based on the measured ToA and information of the responder transmission time.

Both have in common that the position can be calculated without a measurement report from the responders, this means that they do not receive measure reports from the responder, i.e. the transceiver implying the cyclic shift value. This beneficially enables that the transponder applying the cyclic shift value may use very low power reference signals, since only a signal itself and not the content of the signal is transmitted. This enables that high ranges can be determined due to the power constraint for the signaling, especially since no report have to be exchanged.

The configuration of the resources where the reference signals are to be transmitted may be transmitted in unicast or broadcast to the UEs while the UE is in RRC_CONNECTED state or the configuration may be preconfigured in the UE itself.

The configurations may be provided by network entity (e.g. LMF or NG-RAN node) to the UEs or exchanged between the UEs in sidelink mode.

According to embodiments, the transmission between the NG-RAN/network node in the target UE may be as follows. The initiator is a network node, responder is a UE. Here, a UE may be configured with one or more resources where the UE listens to downlink reference signal transmitted by a network node. The UE may be able to derive at least time and/or frequency resources where the UE is expected to receive the downlink reference signal using the said configuration. The UE may additionally be able to derive additional information regarding the downlink reference signal such as transmission comb, transmission comb offset, information describing the reference signal (e.g. ID for generating the sequence, etc), ARFCN, location of the network node and so on.

According to further embodiments, the initiator is a UE, wherein the responder is one or more network nodes. Here, the UE or a group of UEs may be configured with a resource where the UE transmits uplink resource and the UE is provided with a configuration where it may expect to find the downlink response. In response to the transmission of uplink signal by the UE, the network sends a downlink signal on the downlink resource mapped to the uplink resource. The downlink signal may be cyclically shifted in response to the reception time of uplink signal detected at the TRP.

The UE may be configured one or more resources where the UE is expected to search for response from the network node.

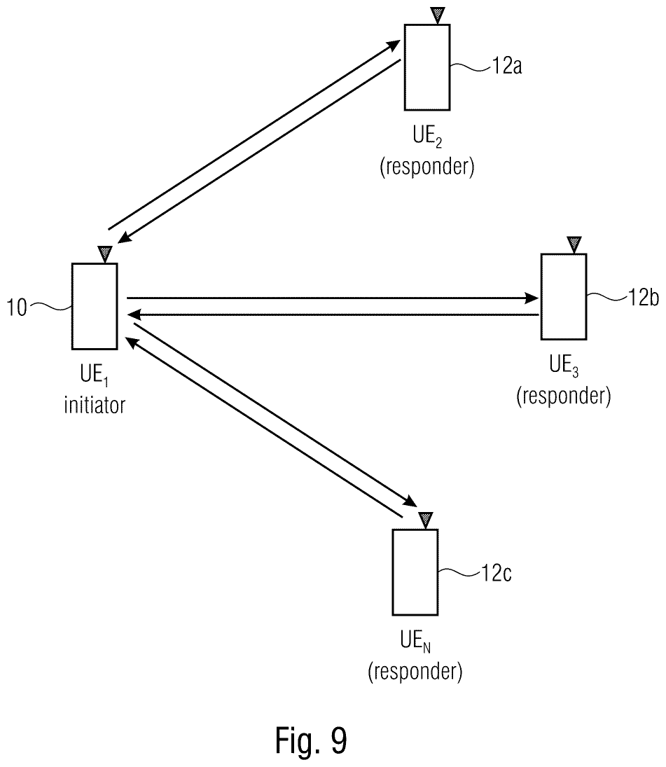

As already discussed above, the above-discussed approach may also be applied to sequential transmissions. This is illustrated with FIG. 9 showing the initiator 10 and three responder UEs 12a, 12b and 12c, all communicating via sidelink. According to embodiment, UE (responder 12a, 12b, 12c) is configured with one or more resources where the UE listens to sidelink reference signal transmitted by another UE (initiator 10). The configuration may be provided by a network node while the sidelink UE is in RRC_CONNECTED state with the network node or the configuration may be a default configuration which is pre-configured by the network to be used in certain scenario (for example, when the UE is out of coverage or in partial coverage). Additionally, the UE is configured a second resource where the responder 12a, 12b, 12c UE responds to the reference signal received from an initiating UE.

Here, a differentiation between different cases according to different embodiments may be made.

### Case 1: One Initiator UE, One or More Responder UEs

In one example, the UE is provided at least one configuration of resource, in which the initiator sends a reference signal. The reference signal may be received by one or more UE. The UE may be configured by the network while in coverage or it may be preconfigured by the network before going to out of coverage on the configuration of the resources where it should expect response from one or more responding UEs.

One typical use case is the scenario where the LCS client resides in the UE, the responders may be temporally fixed UEs. The responder's location is available to the target UE (initiator). The responders may cyclically shift their reference signals dependent on configuration information and the time when the signal transmitted by the initiator is received.

According to an example, a configuration of resource for transmission of initiating reference signal may be mapped to the configuration of resource for receiving response signal. In this example, one or more UE may be separated by means of sequence, resources or cyclic shift values. The initiating UE may identify the responding UE by means of the sequence used. The sequence may be derived based on an identifier of the responding UE. Alternatively or in addition, the responding UE may be identified by means of time or frequency resource the UE has used for response, which may again be based on identifier used to identify the UE or the UE location or the area in the network. For example, the time/frequency resource used by the UE to respond may be derived based on RNTI or serving cell or some identifier that the initiator can associate the responder UE with. Additionally, the network may provide additional information pertaining to the responding UE in one or more messages sent to the initiating UE. Alternatively, such message can be exchanged between the involved UEs in the sidelink (for example, using the PC5 interface or using one or more higher layer signaling protocols conveyed via PC5 interface). Such message may include one or more information about the responding UE, such as its position, whether it is a fixed UE or a moving UE, its transmission characteristics such as antenna position, antenna orientation, antenna pattern and so on.

The responding UEs may be separated from one other by any combination of sequence, time and frequency. For example, a group of UEs located on a given V2X zone may use the same time or frequency resource and each individual UE may identify themselves using different sequence.

Furthermore, the responding UE may only respond to a received transmission from the initiator if it receives the initiator signal with certain characteristics. In line with this example, the UE may respond to the downlink signal sent by the network if
1) The RSRP measured on the downlink resource is above a certain threshold.
2) The RSRP measured on the downlink resource is above a certain threshold and below a second threshold.
3) The reception time measured on the downlink resource is above a certain configured time offset from a reference point in time.
4) The reception time measured on the downlink resource is above a certain value and below a certain value from a reference point in time.
5) A combination one of above conditions.

### Case 2: One Responder UE, One or More Initiator UEs

In one example, the initiator UE and the responders may all be in coverage scenario. In other example, the initiator UE may be in coverage scenario whereas the responders may be in partial coverage scenarios. When at least the initiator is in coverage scenario, the initiator UE may send the range between the initiator and a responder to the network entity for computing position of a target UE (UE whose position is to be determined).

Multiple initiator UEs within network coverage may range a responder UE (which may be in-coverage, out of coverage or partial coverage) and transmit the range between the initiator and responder UE to the network entity. The network entity may use the ranges obtained from different initiators to position a UE.

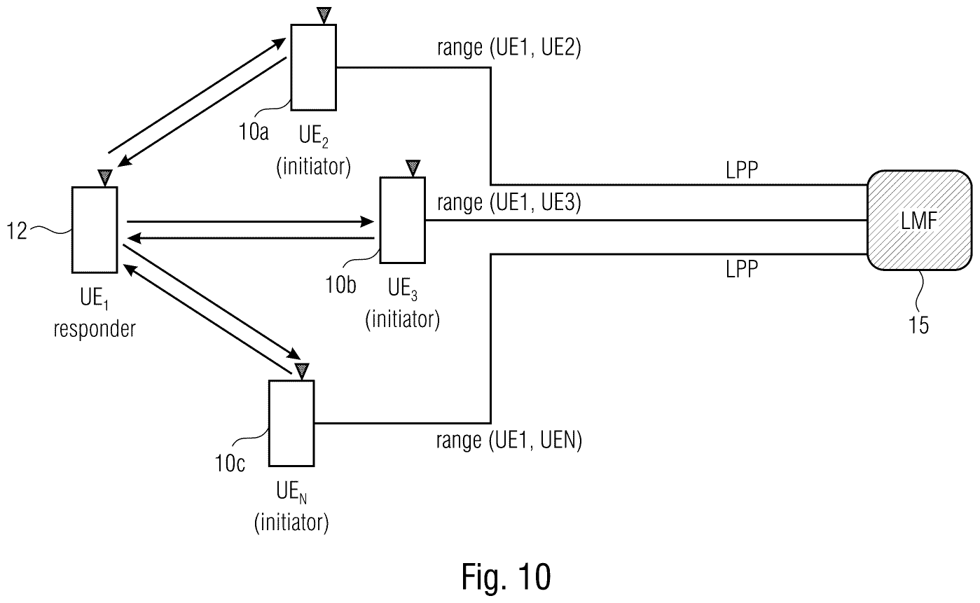

According to an embodiment, this scenario shown by FIG. 9 may be enhanced in cases where one or more fixed node (e.g., RSU) send the initiator request to a target UE as is shown by FIG. 10.

The initiator UE is marked with reference numeral 10a, 10b and 10c, wherein the target UE/responder UE is marked with the reference numeral 12. The target UE to be positioned (UE1) may be in partial or out-of-coverage scenario. For other UEs the position may be known. If the position is known a UE can act as “anchor” for determining the position of other devices. Multiple (anchor 10a, 10b, 10c) UEs having signaling connection to the LMF may range the UE1 12 and transmit the range between the anchor 10a, 10b, 10c UEs and UE1 12 to the LMF. In addition, the anchor UEs may signal any one of the following to the LMF: Anchor position, timestamp, antenna orientation, antenna pattern, RSRP measurements, movement profile of anchors etc.

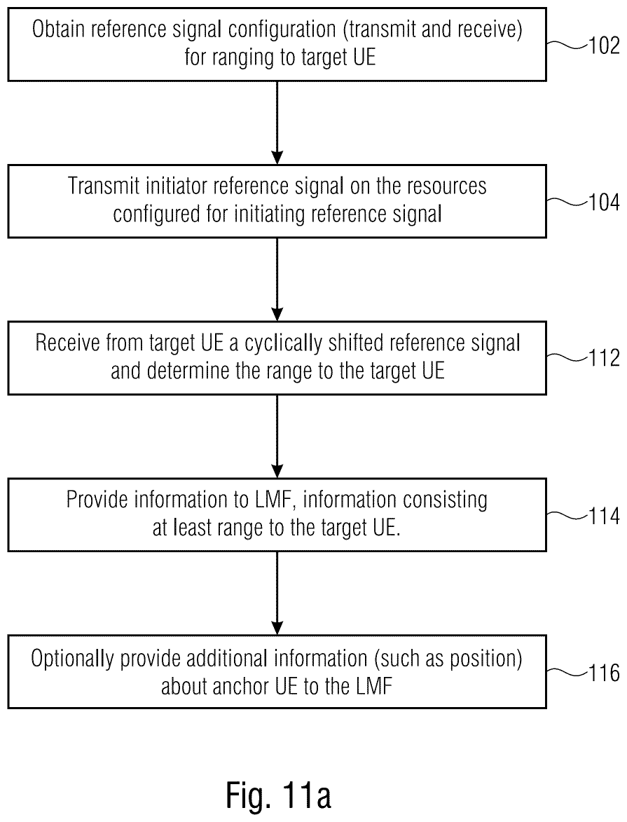

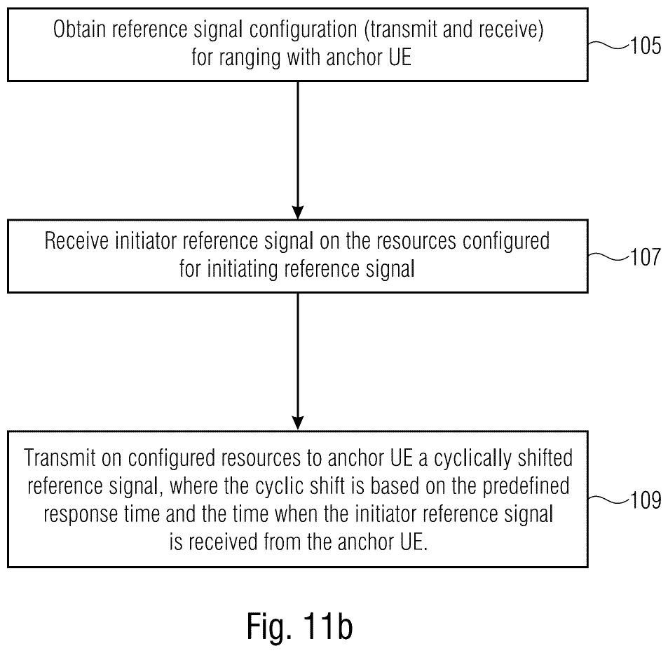

The procedure is illustrated by FIG. 11. According to the embodiment of FIG. 11a, the four steps 102, 104, 112, and 114 may be performed.

102 refers to obtaining a reference signal configuration (transmit and receive) for arranging to the target UE/responder UE.

104 refers to transmitting the initiator reference signal on the resource configured for initiating the reference signal (reference signal 1).

At the responder UE, the next step 112 is performed. The step 112 refers to receiving from a target UE a cyclic-shifted reference signal and determining the target range to the target UE. Note, between the steps 104 and 112 the target UE/responder UE may perform its step of receiving the reference signal and transmitting the cyclic-shifted reference signal. In the last step 114, the information to the LMF is provided, the information may consist at least a range to the target UE.

The step 116 is optional and refers to providing additional information (such as position) about anchor UE to the LMF.

At the target UE/responder UE, the method comprising the steps 105, 107 and 109 is performed. This method is illustrated by FIG. 11b. As it is indicated by the reference numerals, the step 105 is arranged between the step 104 and 112.

In the step 105, the reference signal configuration is obtained (transmitted and received) for arranging with anchor UE. The step is comparable to the step 102. In the next step 107, the initiator reference signal (first reference signal) is received on the resources configured for the initiating reference signal.

In the last step 109, the step of transmitting on configured resources to anchor UE a cyclic-shifted reference signal (reference signal 2) is performed, where the cyclic shift is based on the predefined response time and the time when the initiator reference signal is received from the anchor UE. The step is marked by the reference numeral 105.

Alternatively, one of the UEs may process the range information to determine the UE position and provide the UE position to the LCS client. The UE processing the range information between the target UE and one or more anchor UEs may be one of the anchor UEs themselves or it may be a separate node. One of the anchor nodes may compute the UE position if the anchor node or another UE that has signaling connection to anchor node(s) is configured to compute the position.

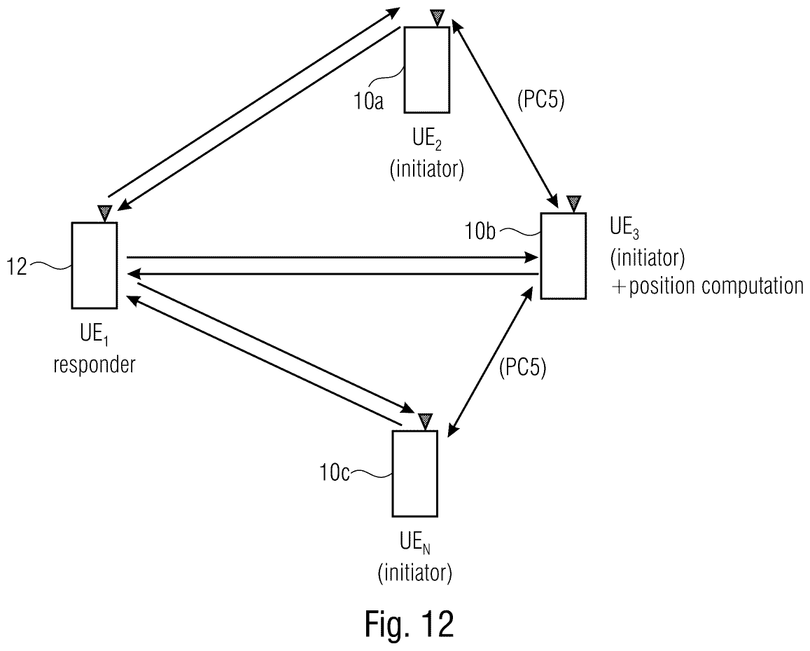

This principle is illustrated by FIG. 12 showing the three initiator UEs 10a, 10b and 10c in combination with the responder UE 12. In FIG. 10, all three UEs 10a, 10b and 10c may communicate with the LMF 15.

An embodiment refers to a user equipment comprising one of the above responder transceivers, wherein the other transceiver is part of the UE (sidelink communication) or part of a base station.

Another embodiment refers to a system comprising at least a user equipment forming the responder UE and another user equipment and/or a base station comprising the other transceiver and forming the initiator UE.

Below, further embodiments will be discussed.

A main embodiment refers to a device supporting RTT measurements. This device may be defined as follows:
The first device (“responder”) is configured to measure ToA on a received signal transmitted by second device (“initiator”).
The first devices is configured to transmit reference signals (RS) useful for ToA measurements as a response to the signal received from the second device.
The device determines a first ToT (t₃) according the recovered OFDM symbol timing of the received signal and a desired TA value
The device determines a second ToT. (t₅).
The device calculates the difference t_{CS}=t₅−t₃.
According to the calculated t_{CS} a CS is applied to the configured RS before transmission at the time t₃

Optional features for this device are:
According to embodiments, the responder receives a configuration to apply resulting in a constant delay t₅−t₂ (the responder can receive the configuration from a location server/LMF or a serving BS or a coordinating UE).
According to embodiments, the desired constant delay is derived from parameters known at the entity determining the range (like NW) and the responder device (UE).

$$E . g . {t}_{3} = n * {t}_{Sym} - TA$$

with
   n is derived from the scheduling of the signal (used slot and symbol in the slot)
   TA is the set by the network (and may remain constant until updated (“semi-persistent”).
According to embodiments, additionally to the CS derived from the difference t₅−t₃ the network may configure an additional CS to distinguish responders using the same REs

Another embodiment refers to a system comprising the initiator and the responder UE, wherein within the system the initiator UE comprises a range determining device or is connected to a range determining device. This embodiment may be defined as follows: Initiator: The initiator sends and its Tx signal is used as a reference for one or more responder. The responder adjusts the timing according to the main method. the range determining entity is the one that makes use of the known reply time to determine the range. This can be the initiator but not necessarily the initiator (for example there could scenarios when the responder signal is measured by the initiator and other devices).

As discussed above, a plurality of responder UEs may answer to the request of the initiator. It should be noted that also a sequential operation (the initiator requests a response sequence and/or several responder answer sequentially) are meant. The responder UE may use the above-discussed CS-Mux. The combination is advantageous to avoid interference that can result due to possible collusions from different responders. For example, the responder generates for each initiator a response and adds these responses before transmission.

### General

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments, the user device, UE, described herein may be one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, or a mobile terminal, or a stationary terminal, or a cellular IoT-UE, or a vehicular UE, or a vehicular group leader, GL, UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

The base station, BS, described herein may be implemented as mobile or immobile base station and may be one or more of a macro cell base station, or a small cell base station, or a central unit of a base station, or a distributed unit of a base station, or an Integrated Access and Backhaul, IAB, node, or a road side unit, or a UE, or a group leader, GL, or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

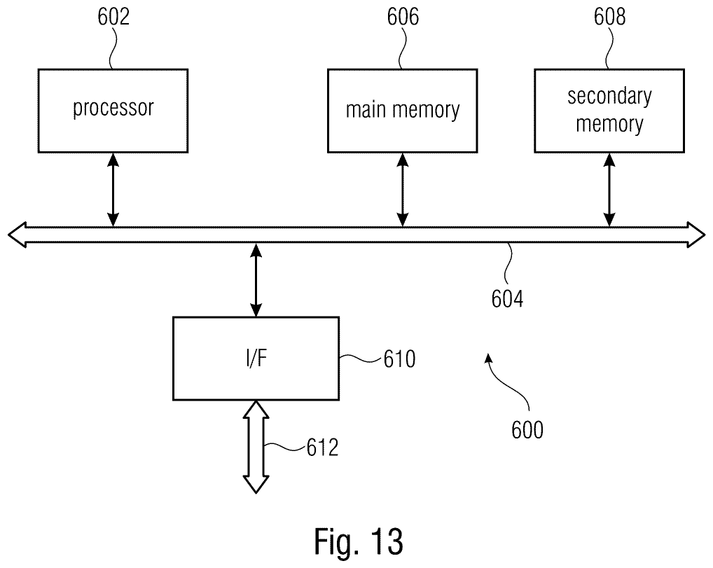

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 13 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier, or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A transceiver configured:
to receive a first reference signal at a second point of time, the first reference signal is transmitted by another transceiver at a first point of time; and
to transmit a second reference signal, wherein the second reference signal is set for transmission at a third point of time, wherein the second reference signal is modified by a cyclic shift defined by a cyclic shift value;
wherein the cyclic shift value is derived from the second point of time (measured time-of-arrival (ToA)) of the received first reference signal and a time information associated with a fifth point of time.

2. The transceiver according to claim 1, wherein second reference signal is to be received by a receiver or the another transceiver performing a ToA measurement based on a cyclic (cross) correlation of the received signal with the configured (unmodified) transmitted reference signal resulting in a sixth point of time; wherein the difference between the sixth point of time and the fifth point of time represents the time-of-flight (ToF).

3. The transceiver according to claim 1, wherein from the transmitted signal a receiver or second transceiver can derive a sixth point of time for the second reference signal is detectable by a receiver or the another transceiver assuming the cyclic correlation, wherein the sixth point of time is different from a fourth point of time representing the time window in which the start of the OFDM symbol of the second reference signal would be received without cyclic shift; and/or
wherein the difference between the fourth point of time and sixth point of time depends on the applied cyclic shift and the this difference is not known at the receiver and/or not required for further processing; and/or
wherein the difference between sixth point of time and the related fifth point represent the time-of-flight between the transmitter and receiver;
wherein the fourth point of time and sixth point of time is identical, if no cyclic shift is applied or if the cyclic shift value is set to zero.

4. The transceiver according to claim 1, wherein the second reference signal modified by a cyclic shift is modified such that the OFDM symbol is cyclic shifted before cyclic prefix insertion; wherein the cyclic prefix is a copy of the end of the OFDM symbol.

5. The transceiver according to claim 1, wherein the cyclic shift is applied in the time domain or in the in the frequency domain;
wherein the cyclic shift is applied in the frequency domain using the formula
$${S}_{( n )} = {R}_{( n )} \cdot {e}^{j α n} , with α = \frac{2 π {t}_{CS}}{{T}_{0} N} ;$$
wherein
N is FFT length
n is index, n∈[0, (N−1)]
R₍ₙ₎ is frequency domain representation of the RS without cyclic shift, with R₍ₙ₎=fft(r₍ₙ₎), r₍ₙ₎ is the time domain signal of the RS without CP)
t_{CS} is the target cyclic shift (in seconds)
T₀ is the sampling period in seconds
S₍ₙ₎ is the frequency domain representation of the RS with cyclic shift.

6. The transceiver according to claim 1, wherein the time information associated with the fifth point of time comprises an desired duration between the fifth point of time and the second point of time; and/or
wherein the difference between the fifth point of time and the third point of time of time represents the needed cyclic shift value and the third point of time is selected according the network synchronization requirements and the scheduling of the second reference signal.

7. The transceiver according to claim 1, wherein the third point of time can be derived from the measured second point of time with
$${t}_{3} = {t}_{2} + {t}_{TX} - TA ;$$
where t_{TX} represents the scheduling of the OFDM symbol in which the second reference signal is transmitted relative to scheduling of the first reference signal, TA is the set by the network or remains constant until updated (“semi-persistent”); and/or
wherein the third point of time is derived from other synchronization or reference signals such as the SSB, CSI-RS, DM-RS, PRS, SRS, SL-PRS, sidelink synchronization signal (SLSS); and/or
wherein the reference signal comprise a synchronization signal such as the SSB, CSI-RS, DM-RS, PRS, SRS, SL-PRS, sidelink synchronization signal (SLSS).

8. The transceiver according to claim 1, wherein a desired duration between the fifth point of time and second point of time is constant or semi-constant (constant for a configurable number of transmissions or duration) or derived from an other parameter, such as transmitter ID; and/or
wherein a desired duration is configured or preconfigured.

9. The transceiver according to claim 1, wherein the (needed) cyclic shift value is calculated from the difference between the fifth point of time and the third point of time by
$${t}_{CS} = {t}_{5} - {t}_{3}$$
$$or$$
$${t}_{CS} = mod ( {t}_{5} - {t}_{3} , {t}_{Sym} )$$
if the difference t₅−t₃ is less than 0 or greater or equal t_{Sym} wherein t_{Sym} is the duration of the OFDM symbol without cyclic prefix.

10. The transceiver according to claim 1, wherein the transceiver is configured with a second cyclic shift value or the second cyclic shift value is derived from other configuration parameters, such as the antenna port, wherein the second cyclic shift value is added to the first cyclic shift value; and/or wherein the second cyclic shift value is coded differently when compared to the first cyclic shift value; and/or
wherein a different cyclic shift is used for different second reference signals to be transmitted to different other transceivers.

11. The transceiver according to claim 1, wherein several transceiver use the same resources in time and frequency and the desired difference between the fifth point of time and second point of time; and/or wherein different cyclic shifts are configured for the several transmitter resulting in several correlation peaks representing the sixth point of time for each transmitted signal; and/or
wherein the configured value is selected allowing an assignment between the correlation peak to the related transceiver; and/or
wherein several transceiver respond to a first reference signal transmitted by another transceiver (initiator) the cyclic shift depends on responder specific information or respondent/anchor ID information; and/or
wherein the third point of time and/or desired duration is derived from parameters known at the transceiver and the other transceiver; and/or
wherein information relating to the difference between fifth and second point of time is available at the transceiver and the other transceiver.

12. The transceiver according to claim 1, wherein the time information associated with the fifth point of time comprise configuration information for the selection of the (second) cyclic shift; and/or
wherein desired duration depends on configuration information comprising information for the calculation or selection of the cyclic shift or range/interval; and/or
wherein information relating to fifth and/or third point of time comprise definitions of two values, especially a value for the timing advance and a OFDM symbol timing to maintain the timing constraints; and/or
wherein information related to determining a third point of time or the third point of time is preconfigured or received from the network or the gNB or the localization server; and/or
wherein the third point of time depends on a system timing constraints or wherein the third point of time is set according to timing advance constraints or wherein a configured third point of time is derived from recovered OFDM symbol timing and timing advance settings.

13. The transceiver according to claim 1, wherein the first and/or second reference signal is configured by the network or a transceiver with respect to one of the following factors: position in frame, slot number and OFDM symbol position in slot, number of OFDM symbols, RS sequence type and RS sequence parameter, bandwidth, center frequency, COMB factor, sequence ID, etc; and/or
wherein an third point of time represent a time of the first sample of the modified OFDM symbol, wherein the modification results in an effective point of time defined by a fifth point of time; and/or
wherein the transmitter is configured to calculate the effective third point of time dependent on the second point of time and a cyclic shift and/or based on a desired duration between the effective third point of time and the second point of time; and/or

14. The transceiver according to claim 1, wherein the transceiver is configured to determine the (effective) second point of time; and/or

15. The transceiver according to claim 18, wherein the transceiver is configured to perform a measurement so as to determine the second point of time or wherein the determination of the third point of time uses a preconfiguration information (for example a system timing boundaries); and/or
wherein a time of flight and/or a round trip is calculable based on a difference between the sixth and first point of time taking into account a desired duration between the second and fifth point of time; and/or
wherein the first reference signal received at the second point of time comprises a predetermined time reference point or a OFDM symbol with cyclic prefix; and/or
wherein the first reference signal comprises an initiator signal initiating a position measurement; and/or
wherein the first reference signal is transmitted as an initiator signal to several transceivers using different cyclic shift values for the second reference signal.

16. The transceiver according to claim 1, wherein a different cyclic shift is used by the transceiver (responder) for a third reference signal for a second other transceiver (initiator).

17. A transceiver which is configured:
to transmit a first reference signal at a first point of time, the first reference signal is received by another transceiver at a second point of time; and
to calculate a time of arrival of a second reference signal based on a measurement performed by another transceiver or to perform a measurement of a time of arrival of a second reference signal; wherein the second reference signal is set for transmission at a third point of time, wherein the second reference signal is modified by a cyclic shift defined by a cyclic shift value; and
to calculate and/or report a range based on calculated or measured time of arrival based on an information on a third or fifth point of time without receiving or accessing a measurement report from the transceiver transmitting the second reference signal;
wherein the cyclic shift value is derived from the second point of time (measured time-of-arrival) of the received first reference signal and a time information associated with a fifth point of time.

18. A user equipment comprising a transceiver according to claim 1, wherein the other transceiver is part of a base station.

19. A user equipment comprising a transceiver according to claim 1, wherein the other transceiver is part of another user equipment, wherein the user equipment and the other user equipment communicating to each other using sidelink communication.

20. A user equipment comprising a transceiver according to claim 1, wherein the user equipment is out of the group comprising:
user device, UE,
a power-limited UE,
a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE,
an IoT UE, e.g., a sensor, an actuator or a UE provided in a campus network to carry out repetitive tasks and needing input from a gateway node at periodic intervals,
a mobile terminal,
a stationary terminal,
a cellular IoT-UE,
a vehicular UE,
a vehicular group leader, GL, UE,
an IoT, or a narrowband IoT, NB-IoT, device, or a WiFi non Access Point STAtion, non-AP STA, e.g., 802.11ax or 802.11be,
a ground based vehicle, or an aerial vehicle,
base station, like e gNB or eNB,
a drone, or a moving base station,
a road side unit, or a building, or any other item or device provided with network connectivity enabling the item/device to communicate using the wireless communication network, e.g., a sensor or actuator,
any other item or device provided with network connectivity enabling the item/device to communicate using a sidelink the wireless communication network, e.g., a sensor or actuator, or any sidelink capable network entity.

21. A system comprising a user equipment comprising a transceiver according to claim 1, wherein the other transceiver is part of a base station, and another user equipment comprising a transceiver according to claim 1, wherein the other transceiver is part of another user equipment, wherein the user equipment and the other user equipment communicating to each other using sidelink communication, or a base station, wherein the other user equipment or the base station comprise the other transceiver.

22. A system according to claim 20, further comprising an additional user equipment comprising a transceiver according to claim 1, wherein the other transceiver is part of a base station, or a user equipment comprising a transceiver according to claim 1, wherein the other transceiver is part of another user equipment, wherein the user equipment and the other user equipment communicating to each other using sidelink communication, the user equipment and the additional user equipment both receiving the first reference signal (RS1).

23. A method for performing localization, comprising:
transmitting a first reference signal at a first point of time, the first reference signal is received by another transceiver at a second point of time;
calculating a time of arrival of the second reference signal based on a measurement performed by another transceiver or to perform a measurement of a time of arrival of the second reference signal; and
calculating a range based on the calculated or measured time of arrival based the known or measured time-of-transmit of RS1 and the known or configured difference between the second and fifth point of time without receiving or accessing a measurement report from the transceiver transmitting the second reference signal; wherein the second reference signal is set for transmission at a third point of time, wherein the second reference signal is modified by a cyclic shift defined by a cyclic shift value; wherein the cyclic shift value is derived from the second point of time (measured time-of-arrival) of the received first reference signal and a time information associated with a fifth point of time.

24. A method for exchanging reference signals, the method comprising:
receiving a first reference signal at a second point of time, the first reference signal is transmitted by another transceiver at a first point of time; and
transmitting a second reference signal, wherein the second reference signal is set for transmission at a third point of time, wherein the second reference signal is modified by a cyclic shift defined by a cyclic shift value;
wherein the cyclic shift value is derived from the second point of time (measured time-of-arrival) of the received first reference signal and a time information associated with a fifth point of time.

25. A non-transitory digital storage medium having a computer program stored thereon to perform the method for performing localization, the method comprising:
transmitting a first reference signal at a first point of time, the first reference signal is received by another transceiver at a second point of time;
calculating a time of arrival of the second reference signal based on a measurement performed by another transceiver or to perform a measurement of a time of arrival of the second reference signal; and
calculating a range based on the calculated or measured time of arrival based the known or measured time-of-transmit of RS1 and the known or configured difference between the second and fifth point of time without receiving or accessing a measurement report from the transceiver transmitting the second reference signal; wherein the second reference signal is set for transmission at a third point of time, wherein the second reference signal is modified by a cyclic shift defined by a cyclic shift value; wherein the cyclic shift value is derived from the second point of time (measured time-of-arrival) of the received first reference signal and a time information associated with a fifth point of time,
when said computer program is run by a computer.

26. A non-transitory digital storage medium having a computer program stored thereon to perform the method for exchanging reference signals, the method comprising:
receiving a first reference signal at a second point of time, the first reference signal is transmitted by another transceiver at a first point of time; and
transmitting a second reference signal, wherein the second reference signal is set for transmission at a third point of time, wherein the second reference signal is modified by a cyclic shift defined by a cyclic shift value;
wherein the cyclic shift value is derived from the second point of time (measured time-of-arrival) of the received first reference signal and a time information associated with a fifth point of time,
when said computer program is run by a computer.
